(19) United States
(12) Patent Application Publication
(10) Pub. No.: US 2019/0096362 A1
(43) Pub. Date: Mar. 28, 2019

(54) METHOD AND SYSTEM FOR GENERATING IMAGES ON DISPLAY

(71) Applicant: Shenzhen China Star Optoelectronics Technology Co., Ltd., Shenzhen, Guangdong (CN)

(72) Inventor: Yanxue WANG, Shenzhen, Guangdong (CN)

(73) Assignee: Shenzhen China Star Optoelectronics Technology Co., Ltd., Shenzhen, Guangdong (CN)

(21) Appl. No.: 15/528,737

(22) PCT Filed: Apr. 20, 2017
(86) PCT No.: PCT/CN2017/081209

§ 371 Date: May 22, 2017

(30) Foreign Application Priority Data
Mar. 30, 2017 (CN) 201710201897.8

(51) Int. Cl. G09G 5/02

(52) U.S. Cl. CPC G09G 5/028; G09G 2320/0666; G09G 2320/0673; G09G 5/026

(57) ABSTRACT

The disclosure provides a method for generating images on a display, including: S1, obtaining first Lab values according to LCH values; S2, obtaining a first original value of a measured display; obtaining first tristimulus values of a color n according to tristimulus values of a pure white image as reference values and the first Lab value; S3, obtaining first output gray-scale values according to the first tristimulus values; S4, obtaining first input gray-scale values according to the first output gray-scale values; S5, obtaining second Lab values according to the first input gray-scale values; S6, comparing the first Lab values and the second Lab values. A system of the disclosure includes an obtaining module, a converting module, a judging module, an outputting module and a correcting module. Compared with the prior art, colors in the display image approach the real colors.

### TECHNICAL FIELD

The disclosure relates to a display technical field, and more particularly to a method and a system for generating images on a display based on a CIE Lab color system.

### DESCRIPTION OF RELATED ART

In the liquid crystal panel industry, colors are generally described by using a CIE1931XYZ color system or a CIE1976LUV color system, which can be further applied in describing view angles and colour difference. The CIELab color system is a better distributed color space compared with the LUV color system, for which most colour difference formulas are based on the CIElab color system to calculate colour difference. With the development of the colour difference formulas (e.g. CIE DE2000), the application of Lab in the display field has been mentioned commonly. The CIE1931 XYZ standard color metric system is regularly utilized to describe colors in the industry, which has the poorer distributed color space compared with the CIElab color system, leading to incorrect in describing chromatic aberration. Although some use the LUV system to define the chromatic aberration, the distribution of the color space is poorer than the LAB system. And the latest chromatic aberration formulas in the industry are mostly provided based on the CIELab color system. With respect to define a pattern, a conventional method in the industry is to define R G B values of the pattern to show on a display, followed by the measurement. But to different displays, properties of screens are various. Same R G B will be different on different panels in the view of an observer. It is a question worthy to be considered that how to measure and adjust colour difference so as to approach the real color.

### SUMMARY

In order to overcome shortcomings of the prior art, the disclosure provides a method and a system for generating images on a display, and the colors showed on the display can be approaching to the real colors.

The disclosure provides a method for generating images on a display, including following steps.

Step S1, obtaining LCH values of a color n, obtaining first Lab values by calculation; converting the LCH values of the color n to Lab for obtaining the first Lab values.

Step S2, measuring a measured display by a color analyzer to obtain a first original value of the measured display. The first original value includes tristimulus values of an R, G, B, W four colors full gray-scale (0˜255), a gamma value of R, G, B, W four colors, tristimulus values of a pure white image, and chromatic values of pure red, pure green and pure blue; obtaining first tristimulus values of the color n according to the tristimulus values of the pure white image as reference values and the first Lab values; obtaining the first tristimulus values by conversion of the first Lab values.

Step S3, obtaining first output gray-scale values according to the first tristimulus values of the color n, the chromatic values of pure red, pure green and pure blue in the first original value, and the tristimulus values of the pure white image; converting the XYZ values to RGB values to obtain the first output gray-scale values.

Step S4, obtaining first input gray-scale values to be input to the display respectively according to the first output gray-scale values and the gamma value.

Step S5, obtaining second Lab values according to the first input gray-scale values and the tristimulus values of RGB three colors in the first original value.

Step S6, comparing the first Lab values and the second Lab values, when the first Lab values and the second Lab values are consistent, outputting the first input gray-scale values to the measured display for display, which is step S7.

Furthermore, a process of obtaining second Lab values according to the first input gray-scale values and the tristimulus values of RGB three colors in the first original value in the step S5 is achieved by: processing the tristimulus values of RGB three colors by mixing colors; obtaining second tristimulus values of the color n; after obtaining the second tristimulus values of the color n, converting the XYZ values to the Lab values to obtain the second Lab values.

Furthermore, in the step S6, when the first Lab values and the second Lab values are compared to be inconsistent, step S8 will be processed, the step S8 is a correction.

Furthermore, the correction includes following steps.

Step S11, obtaining tristimulus values of R₁ᵢₙ, G₁ᵢₙ, B₁ᵢₙ in the first input gray-scale values according to the first input gray-scale value, subsequently obtaining third tristimulus values of the color n corresponding to the first input gray-scale values by calculation; obtaining the third tristimulus values by conversion of the first input gray-scale values.

Step S12, calculating the third tristimulus values to obtain second output gray-scale values; obtaining the second output gray-scale values by conversion of the third tristimulus values.

Step S13, obtaining second input gray-scale values according to the second output gray-scale values and the gamma value corresponding to the first input gray-scale values, outputting the second input gray-scale values.

Step S14, obtaining third Lab values according to the second input gray-scale values.

Step S15, comparing the third Lab values and the first Lab values, if the third Lab values and the first values are consistent, outputting the second input gray-scale values to the measured display for display, which is step S16.

Furthermore, a process of obtaining third Lab values according to the second input gray-scale values in the step S14 is achieved by: converting the RGB values to the XYZ values to obtain RGB tristimulus values corresponding to the second input gray-scale values after obtaining the second input gray-scale values; obtaining the third Lab values by conversion of the obtained RGB tristimulus values.

Furthermore, in the step S15, when the third Lab values and the first Lab values are compared to be inconsistent, step S17 will be processed, the step S17 is a re-correction.

Furthermore, the re-correction includes following steps.

Step S21, respectively processing the second input gray-scale values by ±1˜10 simultaneously in sequence to obtain third input gray-scale values, obtaining the RGB tristimulus values corresponding to the third gray-scale value according to the third input gray-scale values after each process; obtaining the third tristimulus values by conversion of the first input gray-scale values.

Step S22, obtaining fourth Lab values according to the RGB tristimulus values; obtaining the fourth Lab values by conversion of the RGB tristimulus values.

Step S23, comparing the fourth Lab values and the first Lab values, if the fourth Lab values and the first Lab values are consistent, outputting the third input gray-scale values to the measured display for display, which is step S24.

Furthermore, in the step S23, the fourth Lab values and the first Lab values are compared, if they are inconsistent, the step S21 will be re-processed, the step S21 to the step S23 will be repeated until the fourth Lab values and the first Lab values are consistent.

The disclosure further provides a system for generating images on a display. The system includes an obtaining module, a converting module, a judging module, an outputting module and a correcting module.

The obtaining module is configured to obtain LCH values of a color n and obtain a first original value of a measured display, further sending the first original value to the converting module for conversion.

The converting module is configured to convert the LCH values of the color n to first Lab values according to the first original value; as well as processing conversion among XYZ values, RGB values, Lab values and a gray-scale value according to the first Lab values and the first original value.

The judging module is configured to compare the Lab values and the first Lab values. If the Lab values and the first Lab values are consistent, an output command will be sent to the outputting module. If the Lab values and the first Lab values are inconsistent, a correction command will be sent to the correcting module.

The outputting module is configured to output the corresponding gray-scale value to the measured display after receiving the output command.

The correcting module is configured to correct the gray-scale value once after receiving the correction command, and send the corrected gray-scale value to the converting module.

Furthermore, the correcting module is further configured to re-correct the gray-scale value, and send the corrected gray-scale value to the converting module.

Compared with the prior art, the disclosure is based on the CIE Lab color system. The Lab values thereof can be obtained by calculation of lightness (L), hue (H) and color (C) of a given color, and the XYZ values of the color can further be obtained by calculation. The display image of the color is achieved according to the gamma characteristic value of the display and parameters such as R, G, B chromatic values. Appropriateness of the Lab values of the generated display image is judged, if it is inappropriate, the gamma parameter will be corrected to adjust the display image until the proper image is generated, which provides convenience to measurement application of chromatic aberration of the CIELab color system, and the colors in the display image are approaching the real colors.

### BRIEF DESCRIPTION OF THE DRAWINGS

FIG. 1 is a flowchart of a method for generating images on a display according to the disclosure.

FIG. 2 is a flowchart of a correction according to the disclosure.

FIG. 3 is a flowchart of a re-correction according to the disclosure.

FIG. 4 is a block diagram of a system according to the disclosure.

### DETAILED DESCRIPTION OF PREFERRED EMBODIMENTS

The disclosure will be described in detail with reference to embodiments and the accompanying drawings as follows.

As the disclosure is achieved based on a CIELab color system, RGB below represents RGB values of a CIE1931 color system, and XYZ values are the XYZ values of a CIE1931-XYZ standard color system.

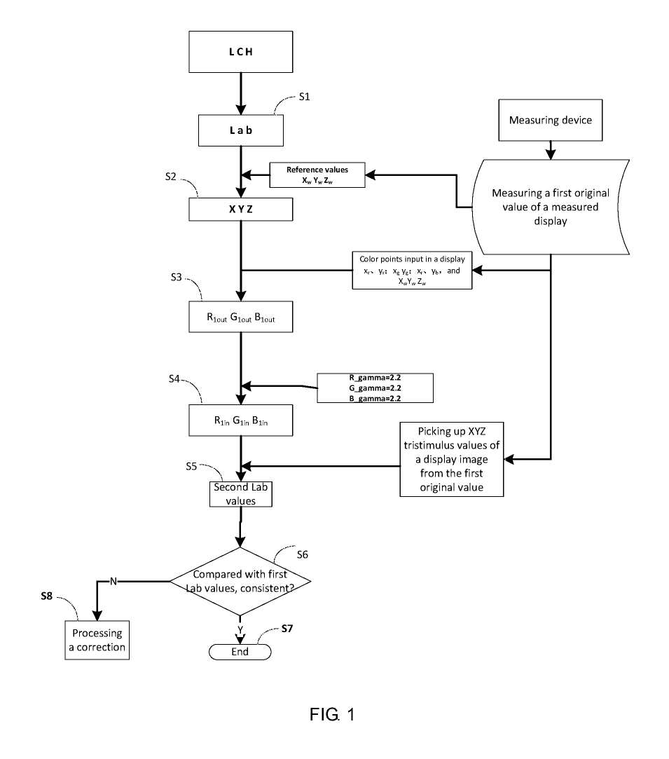

As shown in FIG. 1, a method for generating images on a display of the disclosure includes following steps.

Step S1, obtaining LCH values (values of lightness (L), hue (H) and color (C)) of a color n, obtaining first Lab values by calculation.

Converting the LCH values of the color n to the first Lab values is achieved by calculation according to following formulas:

L=L;

a=C cos(H);

b=C sin(H);

The first Lab values can be obtained according to the formulas above.

Step S2, measuring a measured display by a color analyzer to obtain a first original value of the measured display. The first original value includes tristimulus values of an R, G, B, W four colors full gray-scale (0˜255), a gamma value of R, G, B, W four colors, tristimulus values of a pure white image (X_{w}, Y_{w}, Z_{w}), and chromatic values of pure red, pure green and pure blue (xᵣ, x_{g}, x_{b}; yᵣ, y_{g}, Y_{b}); obtaining first tristimulus values of the color n (X₁ₙ, Y₁ₙ, Z₁ₙ) according to the tristimulus values of the pure white image as reference values and the first Lab values.

The process of obtaining first tristimulus values of the color n (X₁ₙ, Y₁ₙ, Z₁ₙ) according to the tristimulus values of the pure white image and the first Lab values is achieved by converting the Lab values to the XYZ values, specifically as follows:

$${X}_{n} = \{ \begin{matrix}{X}_{w} * {f}_{x}^{3} & {f}_{x} > 0.2069 \\ {X}_{w} * ( {f}_{x} - 0.1379 ) * 0.1284 & otherwise\end{matrix} \\ {Y}_{n} = \{ \begin{matrix}{Y}_{w} * {f}_{y}^{3} & {f}_{x} > 0.2069 \\ {Y}_{w} * ( {f}_{y} - 0.1379 ) * 0.1284 & otherwise\end{matrix} \\ {Z}_{n} = \{ \begin{matrix}{Z}_{w} * {f}_{Z}^{3} & {f}_{x} > 0.2069 \\ {Z}_{w} * ( {f}_{z} - 0.1379 ) * 0.1284 & otherwise\end{matrix}$$

In the formulas, f_{y}=(L+16)/116,

$${f}_{x} = \frac{a}{500} + {f}_{y} ,$$

f_{z}=f_{y}−b/200. The parameter a is the value a in the first Lab values, b is the value b in the first Lab values.

The color analyzer in the disclosure can adopt a CS2000 model or a CA310 model, etc.

Step S3, obtaining first output gray-scale values (R₁ₒᵤₜ, G₁ₒᵤₜ, B₁ₒᵤₜ) according to the first tristimulus values of the color n, the chromatic values of pure red, pure green and pure blue (xᵣ, x_{g}, x_{b}; yᵣ, y_{g}, y_{b}) in the first original value, and the tristimulus values of the pure white image (X_{w}, Y_{w}, Z_{w}).

Specifically, the first output gray-scale values (R₁ₒᵤₜ, G₁ₒᵤₜ, B₁ₒᵤₜ) are obtained by calculation as follows; an inverse matrix M⁻¹ is solved via the matrix M, a conversion matrix from the XYZ values to the RGB values is obtained:

$$[ \begin{matrix}R \\ G \\ B\end{matrix} ] = [ {M}^{- 1} ] [ \begin{matrix}X \\ Y \\ Z\end{matrix} ]$$

In the formula, R=R₁ₒᵤₜ, G=G₁ₒᵤₜ, B=B₁ₒᵤₜ, X=X₁ₙ, Y=Y₁ₙ, Z=Z₁ₙ.

The conversion from the RGB values to the XYZ values is achieved by calculation according to the following formula:

$$[ \begin{matrix}X \\ Y \\ Z\end{matrix} ] = [ M ] [ \begin{matrix}R \\ G \\ B\end{matrix} ]$$

M can be obtained according to following formulas:

$$[ M ] = [ \begin{matrix}{S}_{r} {X}_{r} & {S}_{g} {X}_{g} & {S}_{b} {X}_{b} \\ {S}_{r} {Y}_{r} & {S}_{g} {Y}_{g} & {S}_{b} {Y}_{b} \\ {S}_{r} {Z}_{r} & {S}_{g} {Z}_{g} & {S}_{b} {Z}_{b}\end{matrix} ] \\ [ \begin{matrix}{S}_{r} \\ {S}_{g} \\ {S}_{b}\end{matrix} ] = {[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ]}^{- 1} [ \begin{matrix}{X}_{w} \\ {Y}_{w} \\ {Z}_{w}\end{matrix} ]$$

In the formulas above, Xᵣ=xᵣ/yᵣ, Yᵣ=1, Zᵣ=(1−xᵣ−yᵣ)/yᵣ, X_{g}=x_{g}/y_{g}, Y_{g}=1, Z_{g}=(1−x_{g}−y_{g})/y_{g}, X_{b}=x_{b}/y_{b}, Y_{b}=1, Z_{b}=(1−x_{b}−y_{b})/y_{b}. As the color n can be regarded as a mixed color of red, green and blue three colors, color gamut showed by each of displays can be different, the R color point indicates a color point xᵣ, yᵣ while the display shows pure red; G is x_{g}, y_{g} during pure green; B is x_{b}, y_{b} during pure blue.

Step S4, obtaining first input gray-scale values (R₁ᵢₙ, G₁ᵢₙ, B₁ᵢₙ) to be input to the display respectively according to the first output gray-scale values and the gamma value. The gamma value is 2.2.

The process of obtaining first input gray-scale values to be input to the display respectively according to the first output gray-scale values and the gamma value is achieved by calculation according to following formulas:

R₁ᵢₙ=255*Rₒᵤₜ̂(1/R_gamma);

G₁ᵢₙ=255*Gₒᵤₜ̂(1/G_gamma);

B₁ᵢₙ=255*Bₒᵤₜ̂(1/B_gamma).

R_gamma takes the gamma value corresponding to the R gray-scale in the first original value; G_gamma takes the gamma value corresponding to the G gray-scale in the first original value; B_gamma takes the gamma value corresponding to the B gray-scale in the first original value.

Step S5, obtaining second Lab values according to the first input gray-scale values (R₁ᵢₙ, G₁ᵢₙ, B₁ᵢₙ) and the tristimulus values of RGB three colors in the first original value.

The process of obtaining second Lab values according to the first input gray-scale values (R₁ᵢₙ, G₁ᵢₙ, B₁ᵢₙ) and the tristimulus values of RGB three colors in the first original value by converting from the XYZ values to the Lab values is achieved by calculation as follows.

First, the tristimulus values of RGB three colors are processed by mixing colors; second tristimulus values (X₂ₙ, Y₂ₙ, Z₂ₙ) of the color n are obtained by calculation according to addition principle, specifically as follows.

Xₙ=X_{R}+X_{G}+X_{B};

Yₙ=Y_{R}+Y_{G}+Y_{B};

Zₙ=Z_{R}+Z_{G}+Z_{B};

Xₙ=X₂ₙ, Yₙ=Y₂ₙ, Zₙ=Z₂ₙ.

Second, after obtaining the second tristimulus values of the color n, the second Lab values are obtained by converting the XYZ values to the Lab values, specifically as follows.

$$L = 116 * f ( Y \text{/} {Y}_{w} ) - 16 ;$$

$$a = 500 [ f ( X \text{/} {X}_{w} ) - f ( Y \text{/} {Y}_{w} ) ] ;$$

$$b = 200 [ f ( Y \text{/} {Y}_{w} ) - f ( Z \text{/} {Z}_{w} ) ] ;$$

$$f ( t ) = \{ \begin{matrix}{f}^{1 \text{/} 3 } & if t > {( \frac{6}{29} )}^{3} \\ \frac{1}{3} {( \frac{29}{6} )}^{2} t + \frac{4}{29} & otherwise\end{matrix}$$

In the formulas above, t represents X/X_{w}, Y/Y_{w}; Z/Z_{w}; X=X₂ₙ, Y=Y₂ₙ, Z=Z₂ₙ.

Step S6, comparing the first Lab values and the second Lab values, when the first Lab values and the second Lab values are consistent, outputting the first input gray-scale values to the measured display for display, which is step S7.

When the first Lab values and the second Lab values are compared to be inconsistent, step S8 will be processed, the step S8 is a correction.

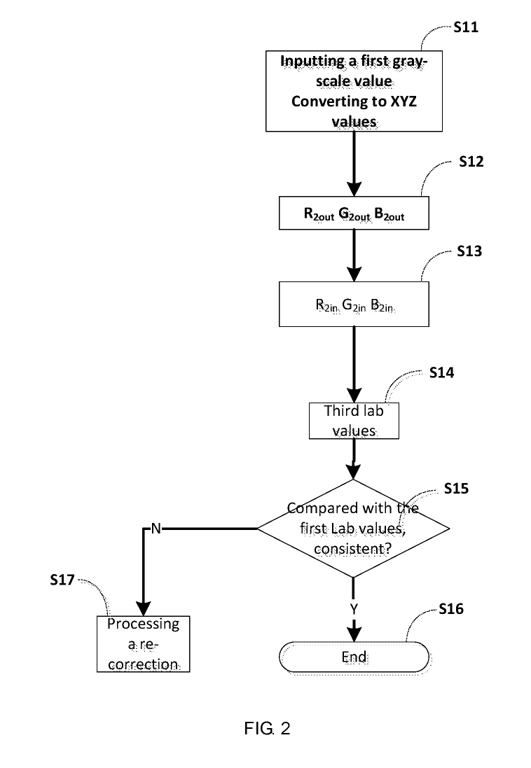

As shown in FIG. 2, the correction includes following steps.

Step S11, obtaining tristimulus values of R₁ᵢₙ, G₁ᵢₙ, B₁ᵢₙ in the first input gray-scale values according to the first input gray-scale values (R₁ᵢₙ, G₁ᵢₙ, B₁ᵢₙ), subsequently obtaining third tristimulus values (X₃ₙ, Y₃ₙ, Z₃ₙ) of the color n corresponding to the first input gray-scale values by calculation.

The process of obtaining the third tristimulus values by conversion of the first input gray-scale values is achieved by calculation as follows.

$$[ \begin{matrix}X \\ Y \\ Z\end{matrix} ] = [ M ] [ \begin{matrix}R \\ G \\ B\end{matrix} ]$$

M is obtained by following formulas:

$$[ M ] = [ \begin{matrix}{S}_{r} {X}_{r} & {S}_{g} {X}_{g} & {S}_{b} {X}_{b} \\ {S}_{r} {Y}_{r} & {S}_{g} {Y}_{g} & {S}_{b} {Y}_{b} \\ {S}_{r} {Z}_{r} & {S}_{g} {Z}_{g} & {S}_{b} {Z}_{b}\end{matrix} ] \\ [ \begin{matrix}{S}_{r} \\ {S}_{g} \\ {S}_{b}\end{matrix} ] = {[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ]}^{- 1} [ \begin{matrix}{X}_{w} \\ {Y}_{w} \\ {Z}_{w}\end{matrix} ]$$

In the formulas above, Xᵣ=xᵣ/yᵣ, Y=1, Zᵣ=(1−xᵣ−yᵣ)/yᵣ, X_{g}=x_{g}/y_{g}, Y_{g}=1, Z_{g}=(1−x_{g}−y_{g})/y_{g}, X_{b}=x_{b}/y_{b}, Y_{b}=1, Z_{b}=(1−x_{b}−y_{b})/y_{b}. As the color n can be regarded as a mixed color of red, green and blue three colors, color gamut showed by each of displays can be different, the R color point indicates a color point xᵣ, yᵣ while the display shows pure red; G is x_{g}, y_{g} during pure green; B is x_{b}, y_{b} during pure blue.

The third tristimulus values (X₃ₙ, Y₃ₙ, Z₃ₙ) of the color n are obtained by processing the tristimulus values of RGB three colors in the color n by mixing colors, specifically obtained by calculation according to following formulas:

X=X_{R}+X_{G}+X_{B};

Y=Y_{R}+Y_{G}+Y_{B};

Z=Z_{R}+Z_{G}+Z_{B}.

In the formulas, X_{R}, Y_{R} and Z_{R} are tristimulus values of R₁ᵢₙ; X_{G}, Y_{G} and Z_{G} are tristimulus values of G₁ᵢₙ; X_{B}, Y_{B} and Z_{B} are tristimulus values of B₁ᵢₙ; X=X₃ₙ, Y=Y₃ₙ, Z=Z₃ₙ.

Step S12, obtaining second output gray-scale values (R₂ₒᵤₜ, G₂ₒᵤₜ, B₂ₒᵤₜ) according to the third tristimulus values.

Specifically, an inverse matrix M⁻¹ is solved via the matrix M, a conversion matrix from the XYZ values to the RGB values is obtained, further obtaining the second output gray-scale values by calculation; specifically is

$$[ \begin{matrix}R \\ G \\ B\end{matrix} ] = [ {M}^{- 1} ] [ \begin{matrix}X \\ Y \\ Z\end{matrix} ]$$

In the formula, R=R₂ₒᵤₜ, G=G₂ₒᵤₜ, B=B₂ₒᵤₜ, X=X₂ₙ, Y=Y₂ₙ, Z=Z₂ₙ.

The conversion from the RGB values to the XYZ values is achieved by calculation according to the following formula:

$$[ \begin{matrix}X \\ Y \\ Z\end{matrix} ] = [ M ] [ \begin{matrix}R \\ G \\ B\end{matrix} ]$$

M is obtained by following formulas:

$$[ M ] = [ \begin{matrix}{S}_{r} {X}_{r} & {S}_{g} {X}_{g} & {S}_{b} {X}_{b} \\ {S}_{r} {Y}_{r} & {S}_{g} {Y}_{g} & {S}_{b} {Y}_{b} \\ {S}_{r} {Z}_{r} & {S}_{g} {Z}_{g} & {S}_{b} {Z}_{b}\end{matrix} ] \\ [ \begin{matrix}{S}_{r} \\ {S}_{g} \\ {S}_{b}\end{matrix} ] = {[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ]}^{- 1} [ \begin{matrix}{X}_{w} \\ {Y}_{w} \\ {Z}_{w}\end{matrix} ]$$

In the formulas above, Xᵣ=xᵣ/yᵣ, Yᵣ=1, Zᵣ=(1−xᵣ−yᵣ)/yᵣ, X_{g}=x_{g}/y_{g}, Y_{g}=1, Z_{g}=(1−x_{g}−y_{g})/y_{g}, X_{b}=x_{b}/y_{b}, Y_{b}=1, Z_{b}=(1−X_{b}−y_{b})/y_{b}. As the color n can be regarded as a mixed color of red, green and blue three colors, color gamut showed by each of displays can be different, the R color point indicates a color point xᵣ, yᵣ while the display shows pure red; G is x_{g}, y_{g} during pure green; B is x_{b}, y_{b} during pure blue.

Step S13, obtaining second input gray-scale values (R₂ᵢₙ, G₂ᵢₙ, B₂ᵢₙ) according to the second output gray-scale values and the gamma value corresponding to the first input gray-scale values, outputting the second input gray-scale values.

R₂ᵢₙ=255*R₂ₒᵤₜ̂(1/R—gamma);

G₂ᵢₙ=255*G₂ₒᵤₜ̂(1/G_gamma);

G₂ᵢₙ=255*G₂ₒᵤₜ̂(1/G_gamma)

R_gamma takes the gamma value corresponding to the R₁ᵢₙ gray-scale; G_gamma takes the gamma value corresponding to the G₁ᵢₙ gray-scale; B_gamma takes the gamma value corresponding to the B₁ᵢₙ gray-scale.

Step S14, obtaining third Lab values according to the second input gray-scale values.

The calculation specifically is first obtaining the RGB tristimulus values corresponding to the second input gray-scale values by calculation after obtaining the second input gray-scale values. The RGB tristimulus values are obtained by conversion of the RGB values, specifically calculated as follows:

$$[ \begin{matrix}X \\ Y \\ Z\end{matrix} ] = [ M ] [ \begin{matrix}R \\ G \\ B\end{matrix} ]$$

M is obtained by following formulas:

$$[ M ] = [ \begin{matrix}{S}_{r} {X}_{r} & {S}_{g} {X}_{g} & {S}_{b} {X}_{b} \\ {S}_{r} {Y}_{r} & {S}_{g} {Y}_{g} & {S}_{b} {Y}_{b} \\ {S}_{r} {Z}_{r} & {S}_{g} {Z}_{g} & {S}_{b} {Z}_{b}\end{matrix} ] \\ [ \begin{matrix}{S}_{r} \\ {S}_{g} \\ {S}_{b}\end{matrix} ] = {[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ]}^{- 1} [ \begin{matrix}{X}_{w} \\ {Y}_{w} \\ {Z}_{w}\end{matrix} ]$$

In the formulas above, Xᵣ=xᵣ/yᵣ, Yᵣ=1, Zᵣ=(1−xᵣ−yᵣ)/yᵣ, X_{g}=x_{g}/y_{g}, Y_{g}=1, Z_{g}=(1−x_{g}−y_{g})/y_{g}, X_{b}=X_{b}/y_{b}, Y_{b}=1, Z_{b}=(1−x_{b}−y_{b})/y_{b}. As the color n can be regarded as a mixed color of red, green and blue three colors, color gamut showed by each of displays can be different, the R color point indicates a color point xᵣ, yᵣ while the display shows pure red; G is x_{g}, y_{g} during pure green; B is x_{b}, y_{b} during pure blue.

Second, the third Lab values are obtained by conversion of the obtained RGB tristimulus values, which are specifically achieved as follows:

$$L = 116 * f ( Y \text{/} {Y}_{w} ) - 16 ;$$

$$a = 500 [ f ( X \text{/} {X}_{w} ) - f ( Y \text{/} {Y}_{w} ) ] ;$$

$$b = 200 [ f ( Y \text{/} {Y}_{w} ) - f ( Z \text{/} {Z}_{w} ) ] ;$$

$$f ( t ) = \{ \begin{matrix}{f}^{1 \text{/} 3 } & if t > {( \frac{6}{29} )}^{3} \\ \frac{1}{3} {( \frac{29}{6} )}^{2} t + \frac{4}{29} & otherwise\end{matrix}$$

In the formulas above, t represents X/X_{w}, Y/Y_{w}, Z/Z_{w}. X, Y and Z are the RGB tristimulus values.

Step S15, comparing the third Lab values and the first Lab values, if the third Lab values and the first Lab values are consistent, outputting the second input gray-scale values to the measured display for display, which is step S16.

When the third Lab values and the first Lab values are compared to be inconsistent, step S17 will be processed, the step S17 is a re-correction.

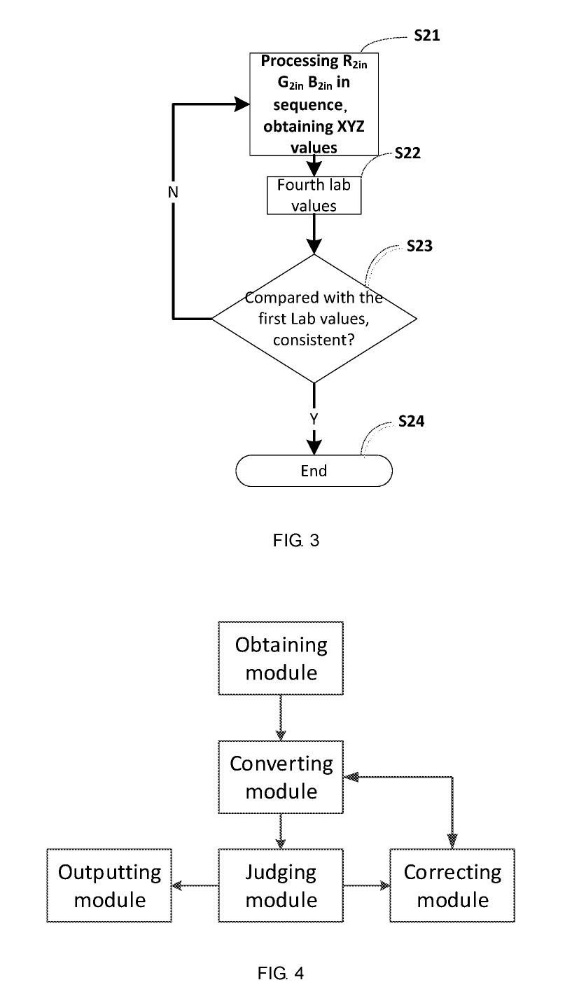

As shown in FIG. 3, the re-correction includes following steps.

Step S21, respectively processing the second input gray-scale values (R₂ᵢₙ, G₂ᵢₙ, B₂ᵢₙ) by ±1˜10 simultaneously in sequence, meaning processing R₂ᵢₙ, G₂ᵢₙ and B₂ᵢₙ by ±1˜10 simultaneously each time, the sequence is from 1 to obtain third input gray-scale values (R₃ᵢₙ, G₃ᵢₙ, B₃ᵢₙ), obtaining the RGB tristimulus values (the XYZ values) corresponding to a third gray-scale value after each process according to the third input gray-scale values.

The process of obtaining the RGB tristimulus values corresponding to the third gray-scale value by converting the RGB values to the XYZ values according to the third input gray-scale values is specifically achieved by calculation according to the following formula:

$$[ \begin{matrix}X \\ Y \\ Z\end{matrix} ] = [ M ] [ \begin{matrix}R \\ G \\ B\end{matrix} ]$$

M is obtained by following formulas:

$$[ M ] = [ \begin{matrix}{S}_{r} {X}_{r} & {S}_{g} {X}_{g} & {S}_{b} {X}_{b} \\ {S}_{r} {Y}_{r} & {S}_{g} {Y}_{g} & {S}_{b} {Y}_{b} \\ {S}_{r} {Z}_{r} & {S}_{g} {Z}_{g} & {S}_{b} {Z}_{b}\end{matrix} ] \\ [ \begin{matrix}{S}_{r} \\ {S}_{g} \\ {S}_{b}\end{matrix} ] = {[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ]}^{- 1} [ \begin{matrix}{X}_{w} \\ {Y}_{w} \\ {Z}_{w}\end{matrix} ]$$

In the formulas above, Xᵣ=xᵣ/yᵣ, Yᵣ=1, Zᵣ=(1−xᵣ−yᵣ)/yᵣ, X_{g}=x_{g}/y_{g}, Y_{g}=1, Z_{g}=(1−x_{g}−y_{g})/y_{g}, X_{b}=X_{b}/y_{b}, Y_{b}=1, Z_{b}=(1−x_{b}−y_{b})/y_{b}. As the color n can be regarded as a mixed color of red, green and blue three colors, color gamut showed by each of displays can be different, the R color point indicates a color point xᵣ, yᵣ while the display shows pure red; G is x_{g}, y_{g} during pure green; B is x_{b}, y_{b} during pure blue.

Step S22, obtaining fourth Lab values according to the RGB tristimulus values.

The process of obtaining the fourth Lab values by conversion of the RGB tristimulus values is achieved by following formulas:

$$L = 116 * f ( Y \text{/} {Y}_{w} ) - 16 ;$$

$$a = 500 [ f ( X \text{/} {X}_{w} ) - f ( Y \text{/} {Y}_{w} ) ] ;$$

$$b = 200 [ f ( Y \text{/} {Y}_{w} ) - f ( Z \text{/} {Z}_{w} ) ] ;$$

$$f ( t ) = \{ \begin{matrix}{f}^{1 \text{/} 3 } & if t > {( \frac{6}{29} )}^{3} \\ \frac{1}{3} {( \frac{29}{6} )}^{2} t + \frac{4}{29} & otherwise\end{matrix}$$

In the formulas above, t represents X/X_{w}, Y/Y_{w}, Z/Z_{w}. X, Y and Z are the RGB tristimulus values.

Step S23, comparing the fourth Lab values and the first Lab values, if the fourth Lab values and the first Lab values are consistent, outputting the third input gray-scale values to the measured display for display, which is step S24. If the fourth Lab values and the first Lab values are inconsistent, the step S21 will be re-processed, the step S21 to the step S23 will be repeated until the fourth Lab values and the first Lab values are consistent.

As shown in FIG. 4, a system for generating images on a display of the disclosure includes an obtaining module, a converting module, a judging module, an outputting module and a correcting module.

The obtaining module is configured to obtain LCH values of a color n and obtain a first original value of a measured display, further sending the first original value to the converting module for conversion.

The converting module is configured to convert the LCH values of the color n to first Lab values according to the first original value; as well as processing conversion among XYZ values, RGB values, Lab values and a gray-scale value according to the first Lab values and the first original value.

The judging module is configured to compare the Lab values and the first Lab values. If the Lab values and the first Lab values are consistent, an output command will be sent to the outputting module. If the Lab values and the first Lab values are inconsistent, a correction command will be sent to the correcting module.

The outputting module is configured to output the corresponding gray-scale value to the measured display after receiving the output command.

The correcting module is configured to correct the gray-scale value once after receiving the correction command, and send the corrected gray-scale value to the converting module.

The correcting module is further configured to re-correct the gray-scale value, and send the corrected gray-scale value to the converting module.

The methods of correction and re-correction have been illustrated in detail, which will not be repeated.

In the following, the method for generating images on a display and the system for generating images on a display will be combined to briefly describe specific steps.

Step S1, the obtaining module obtains the LCH values (values of lightness (L), hue (H) and color (C)) of the color n, and obtain the first Lab values by calculation of the converting module.

Step S2, measuring a measured display by a color analyzer to obtain a first original value of the measured display, and sending the first original value to the obtaining module; obtaining first tristimulus values of the color n (X₁ₙ, Y₁ₙ, Z₁ₙ) according to the tristimulus values of the pure white image as reference values and the first Lab values.

Step S3, the converting module obtains first output gray-scale values (R₁ₒᵤₜ, G₁ₒᵤₜ, B₁ₒᵤₜ) according to the first tristimulus values of the color n, the chromatic values of pure red, pure green and pure blue (xᵣ, x_{g}, x_{b}; yᵣ, y_{g}, y_{b}) in the first original value, and the tristimulus values of the pure white image (X_{w}, Y_{w}, Z_{w}).

Step S4, the converting module obtains first input gray-scale values (R₁ᵢₙ, G₁ᵢₙ, B₁ᵢₙ) to be input to the display respectively according to the first output gray-scale values and the gamma value.

Step S5, the converting module obtains the second Lab values according to the first input gray-scale values (R₁ᵢₙ, G₁ᵢₙ, B₁ᵢₙ) and the tristimulus values of RGB three colors in the first original value, and sends the second Lab values to the judging module.

Step S6, the judge module compares the first Lab values and the second Lab values. When the first Lab values and the second Lab values are consistent, step S7 will be processed, which is sending the first input gray-scale values to the measured display through the outputting module for display.

When the first Lab values and the second Lab values are compared to be inconsistent, step S8 will be processed, the step S8 is a correction.

The correction includes following steps.

Step S11, the converting module obtains tristimulus values of R₁ᵢₙ, G₁ᵢₙ, B₁ᵢₙ in the first input gray-scale values according to the first input gray-scale values (R₁ᵢₙ, G₁ᵢₙ, B₁ᵢₙ), and subsequently obtains third tristimulus values (X₃ₙ, Y₃ₙ, Z₃ₙ) of the color n corresponding to the first input gray-scale values by calculation.

Step S12, the converting module obtains second output gray-scale values (R₂ₒᵤₜ, G₂ₒᵤₜ, B₂ₒᵤₜ) according to the third tristimulus values and sends the second output gray-scale values to the correcting module.

Step S13, the correcting module obtains second input gray-scale values (R₂ᵢₙ, G₂ᵢₙ, B₂ᵢₙ) according to the second output gray-scale values and the gamma value corresponding to the first input gray-scale values, subsequently outputs the second input gray-scale values to the converting module.

Step S14, the converting module obtains third Lab values according to the second input gray-scale values, and sends the third Lab values to the judging module for judgement.

Step S15, the judging module compares the third Lab values and the first Lab values, if the third Lab values and the first values are consistent, step S16 will be processed, which is outputting the second input gray-scale values to the measured display through the outputting module for display.

When the third Lab values and the first Lab values are compared to be inconsistent, step S17 will be processed, the step S17 is a re-correction.

The re-correction includes following steps.

Step S21, the correcting module respectively processes the second input gray-scale values (R₂ᵢₙ, G₂ᵢₙ, B₂ᵢₙ) by ±1˜10 in sequence to obtain third input gray-scale values (R₃ᵢₙ, G₃ᵢₙ, B₃ᵢₙ), the third input gray-scale values are sent to the converting module for calculation after each process, the RGB tristimulus values corresponding to the third gray-scale value are obtained by calculation.

Step S22, the converting module obtains fourth Lab values according to the RGB tristimulus values and sends the fourth Lab values to the judging module for judgement.

Step S23, the judging module compares the fourth Lab values and the first Lab values, if the fourth Lab values and the first Lab values are consistent, the judging module outputs the third input gray-scale values to the measured display through the outputting module for display, which is step S24. If the fourth Lab values and the first Lab values are inconsistent, the step S21 will be re-processed, the step S21 to the step S23 will be repeated until the fourth Lab values and the first Lab values are consistent.

Although the disclosure is illustrated with reference to specific embodiments, a person skilled in the art should understand that various modifications on forms and details can be achieved within the spirit and scope of the disclosure limited by the claims and the counterpart.

What is claimed is:

1. A method for generating images on a display, comprising following steps:
step S1, obtaining LCH values of a color n, obtaining first Lab values by calculation; converting the LCH values of the color n to Lab for obtaining the first Lab values;
step S2, measuring a measured display by a color analyzer to obtain a first original value of the measured display, the first original value comprising tristimulus values of an R, G, B, W four colors full gray-scale, a gamma value of R, G, B, W four colors, tristimulus values of a pure white image, and chromatic values of pure red, pure green and pure blue; obtaining first tristimulus values of the color n according to the tristimulus values of the pure white image as reference values and the first Lab values; obtaining the first tristimulus values by conversion of the first Lab values;
step S3, obtaining first output gray-scale values according to the first tristimulus values of the color n, the chromatic values of pure red, pure green and pure blue in the first original value, and the tristimulus values of the pure white image; converting the XYZ values to RGB values to obtain the first output gray-scale values;
step S4, obtaining first input gray-scale values to be input to the display respectively according to the first output gray-scale values and the gamma value;
step S5, obtaining second Lab values according to the first input gray-scale values and the tristimulus values of RGB three colors in the first original value;
step S6, comparing the first Lab values and the second Lab values, when the first Lab values and the second Lab values are consistent, outputting the first input gray-scale values to the measured display for display, which is step S7.

2. The method for generating images on a display according to claim 1, wherein a process of obtaining second Lab values according to the first input gray-scale values and the tristimulus values of RGB three colors in the first original value in the step S5 is achieved by: processing the tristimulus values of the RGB three colors by mixing colors; obtaining second tristimulus values of the color n; after obtaining the second tristimulus values of the color n, converting the XYZ values to the Lab values to obtain the second Lab values.

3. The method for generating images on a display according to claim 1, wherein in the step S6, when the first Lab values and the second Lab values are compared to be inconsistent, step S8 will be processed, the step S8 is a correction.

4. The method for generating images on a display according to claim 2, wherein in the step S6, when the first Lab values and the second Lab values are compared to be inconsistent, step S8 will be processed, the step S8 is a correction.

5. The method for generating images on a display according to claim 3, wherein the correction comprises following steps:
step S11, obtaining tristimulus values of R₁ᵢₙ, G₁ᵢₙ, B₁ᵢₙ in the first input gray-scale value according to the first input gray-scale values, subsequently obtaining third tristimulus values of the color n corresponding to the first input gray-scale values; obtaining the third tristimulus values by conversion of the first input gray-scale values;
step S12, obtaining second output gray-scale values according to the third tristimulus values; obtaining the second output gray-scale values by conversion of the third tristimulus values;
step S13, obtaining second input gray-scale values according to the second output gray-scale values and the gamma value corresponding to the first input gray-scale values, outputting the second input gray-scale values;
step S14, obtaining third Lab values according to the second input gray-scale values;
step S15, comparing the third Lab values and the first Lab values, if the third Lab values and the first values are consistent, outputting the second input gray-scale values to the measured display for display, which is step S16.

6. The method for generating images on a display according to claim 4, wherein the correction comprises following steps:
step S11, obtaining tristimulus values of R₁ᵢₙ, G₁ᵢₙ, B₁ᵢₙ in the first input gray-scale values according to the first input gray-scale values, subsequently obtaining third tristimulus values of the color n corresponding to the first input gray-scale values; obtaining the third tristimulus values by conversion of the first input gray-scale values;
step S12, obtaining second output gray-scale values according to the third tristimulus values; obtaining the second output gray-scale values by conversion of the third tristimulus values;
step S13, obtaining second input gray-scale values according to the second output gray-scale values and the gamma value corresponding to the first input gray-scale values, outputting the second input gray-scale values;
step S14, obtaining third Lab values according to the second input gray-scale values;
step S15, comparing the third Lab values and the first Lab values, if the third Lab values and the first values are consistent, outputting the second input gray-scale values to the measured display for display, which is step S16.

7. The method for generating images on a display according to claim 5, wherein a process of obtaining third Lab values in the step according to the second input gray-scale values is achieved by: converting the RGB values to the XYZ values to obtain RGB tristimulus values corresponding to the second input gray-scale values after obtaining the second input gray-scale values; obtaining the third Lab values by conversion of the obtained RGB tristimulus values.

8. The method for generating images on a display according to claim 6, wherein a process of obtaining third Lab values according to the second input gray-scale values in the step S14 is achieved by: converting the RGB values to the XYZ values to obtain RGB tristimulus values corresponding to the second input gray-scale values after obtaining the second input gray-scale values; obtaining the third Lab values by conversion of the obtained RGB tristimulus values.

9. The method for generating images on a display according to claim 5, wherein in the step S15, when the third Lab values and the first Lab values are compared to be inconsistent, step S17 will be processed, the step S17 is a re-correction.

10. The method for generating images on a display according to claim 6, wherein in the step S15, when the third Lab values and the first Lab values are compared to be inconsistent, step S17 will be processed, the step S17 is a re-correction.

11. The method for generating images on a display according to claim 7, wherein in the step S15, when the third Lab values and the first Lab values are compared to be inconsistent, step S17 will be processed, the step S17 is a re-correction.

12. The method for generating images on a display according to claim 9, wherein the re-correction comprises following steps:
step S21, respectively processing the second input gray-scale values by ±1˜10 simultaneously in sequence to obtain third input gray-scale values, obtaining the RGB tristimulus values corresponding to the third gray-scale value according to the third input gray-scale values after each process; obtaining the third tristimulus values by conversion of the first input gray-scale values;
step S22, obtaining fourth Lab values according to the RGB tristimulus values; obtaining the fourth Lab values by conversion of the RGB tristimulus values;
step S23, comparing the fourth Lab values and the first Lab values, if the fourth Lab values and the first Lab values are consistent, outputting the third input gray-scale values to the measured display for display, which is step S24.

13. The method for generating images on a display according to claim 10, wherein the re-correction comprises following steps:
step S21, respectively processing the second input gray-scale values by ±1˜10 simultaneously in sequence to obtain third input gray-scale values, obtaining the RGB tristimulus values corresponding to the third gray-scale value according to the third input gray-scale values after each process; obtaining the third tristimulus values by conversion of the first input gray-scale values;
step S22, obtaining fourth Lab values according to the RGB tristimulus values; obtaining the fourth Lab values by conversion of the RGB tristimulus values;
step S23, comparing the fourth Lab values and the first Lab values, if the fourth Lab values and the first Lab values are consistent, outputting the third input gray-scale values to the measured display for display, which is step S24.

14. The method for generating images on a display according to claim 11, wherein the re-correction comprises following steps:
step S21, respectively processing the second input gray-scale values by ±1˜10 simultaneously in sequence to obtain third input gray-scale values, obtaining the RGB tristimulus values corresponding to the third gray-scale value according to the third input gray-scale values after each process; obtaining the third tristimulus values by conversion of the first input gray-scale values;
step S22, obtaining fourth Lab values according to the RGB tristimulus values; obtaining the fourth Lab values by conversion of the RGB tristimulus values;
step S23, comparing the fourth Lab values and the first Lab values, if the fourth Lab values and the first Lab values are consistent, outputting the third input gray-scale values to the measured display for display, which is step S24.

15. The method for generating images on a display according to claim 12, wherein in the step S23, the fourth Lab values and the first Lab values are compared, if they are inconsistent, the step S21 will be re-processed, the step S21 to the step S23 will be repeated until the fourth Lab values and the first Lab values are consistent.

16. The method for generating images on a display according to claim 13, wherein in the step S23, the fourth Lab values and the first Lab values are compared, if they are inconsistent, the step S21 will be re-processed, the step S21 to the step S23 will be repeated until the fourth Lab values and the first Lab values are consistent.

17. The method for generating images on a display according to claim 14, wherein in the step S23, the fourth Lab values and the first Lab values are compared, if they are inconsistent, the step S21 will be re-processed, the step S21 to the step S23 will be repeated until the fourth Lab values and the first Lab values are consistent.

18. A system for generating images on a display, the system comprising:
an obtaining module, configured to obtain LCH values of a color n and obtain a first original value of a measured display, further sending the first original value to a converting module for conversion;
the converting module, configured to convert the LCH values of the color n to first Lab values according to the first original value; as well as processing conversion among XYZ values, RGB values, Lab values and a gray-scale value according to the first Lab values and the first original value;
a judging module, configured to compare the Lab values and the first Lab values, if the Lab values and the first Lab values are consistent, sending an output command to an outputting module, if the Lab values and the first Lab values are inconsistent, sending a correction command to a correcting module;
the outputting module, configured to output the corresponding gray-scale value to the measured display after receiving the output command;
the correcting module, configured to correct the gray-scale value once after receiving the correction command, and send the corrected gray-scale value to the converting module.

19. The system for generating images on a display according to claim 18, wherein the correcting module is further configured to re-correct the gray-scale value, and send the corrected gray-scale value to the converting module.
